(19) United States
(12) Patent Application Publication
(10) Pub. No.: US 2009/0164555 A1
(43) Pub. Date: Jun. 25, 2009

(54) INITIATING EXECUTION OF SERVER-CONTROLLED TASKS

(75) Inventors: James T. BEZANSON, Snohomish, WA (US); Jeffrey B. JENNINGS, Raliegh, NC (US); Kofi KEKESSIE, Durham, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 11/840,196

(22) Filed: Dec. 21, 2007

(51) Int. Cl. G06F 15/16

(52) U.S. Cl. 709/203

(57) ABSTRACT

A method, computer program product, and system for initiating execution of server-controlled tasks are provided. The method, computer program product, and system provide for providing a server-controlled task, the server-controlled task being a task that is to be initiated by a server and executed at a client in communication with the server, and triggering initiation of the server-controlled task by the server from the client.

### FIELD OF THE INVENTION

The present invention relates generally to initiating execution of server-controlled tasks.

### BACKGROUND OF THE INVENTION

In certain environments, such as a preboot execution environment (PXE), execution of particular tasks (e.g., a basic scan) on a client must be initiated by a server. These tasks are sometimes referred to as server-controlled tasks. In order to execute a server-controlled task on the client, the server typically has to be directly interfaced to initiate execution of the server-controlled task. For example, an administrator has to physically go to the server or remotely access the server through scripts or a remote access terminal to schedule initiation of a server-controlled task on the client. This is inconvenient and could potentially cause delays.

### SUMMARY OF THE INVENTION

A method, computer program product, and system for initiating execution of server-controlled tasks are provided. The method, computer program product, and system provide for providing a server-controlled task, the server-controlled task being a task that is to be initiated by a server and executed at a client in communication with the server, and triggering initiation of the server-controlled task by the server from the client.

By allowing a client to trigger initiation of a server-controlled task, a direct interface with a server is no longer necessary. As a result, initiating execution of server-controlled tasks by the server is more convenient, less likely to cause delays, and less prone to errors.

### BRIEF DESCRIPTION OF THE DRAWINGS

FIG. 1 is a process flow of a method for initiating execution of server-controlled tasks according to an implementation of the invention.

FIG. 2 depicts a block diagram of a system according to an implementation of the invention.

FIG. 3 shows an example of a PXE session according to an implementation of the invention.

FIG. 4 illustrates a block diagram of a system according to an implementation of the invention.

FIG. 5 depicts a process flow of a method for initiating execution of server-controlled tasks according to an implementation of the invention.

FIG. 6 illustrates a block diagram of a data processing system with which implementations of the invention can be implemented.

### DETAILED DESCRIPTION

The present invention generally relates to initiating execution of server-controlled tasks. The following description is presented to enable one of ordinary skill in the art to make and use the invention and is provided in the context of a patent application and its requirements. The present invention is not intended to be limited to the implementations shown, but is to be accorded the widest scope consistent with the principles and features described herein.

Server-controlled tasks are tasks that execute at a client, but must be initiated by a server in communication with the client. For example, in a preboot execution environment (PXE), execution of a basic scan at a PXE client (i.e., a client that implements the PXE protocol) is controlled and initiated by a PXE server (i.e., a server that implements the PXE protocol). Typically, a person has to directly interface with the PXE server (e.g., an administrator has to physically go to the PXE server or remotely access the PXE server through scripts or a remote access terminal) in order to initiate execution of the basic scan at the PXE client or to schedule initiation of the basic scan at the PXE client.

Having to directly interface with a server before execution of a server-controlled task can be initiated is inconvenient. In addition, delays may result from having to wait for an administrator to directly interface with the server. Further, the direct interface process is prone to error since the administrator may, for instance, initiate an incorrect task or initiate the task at an incorrect client.

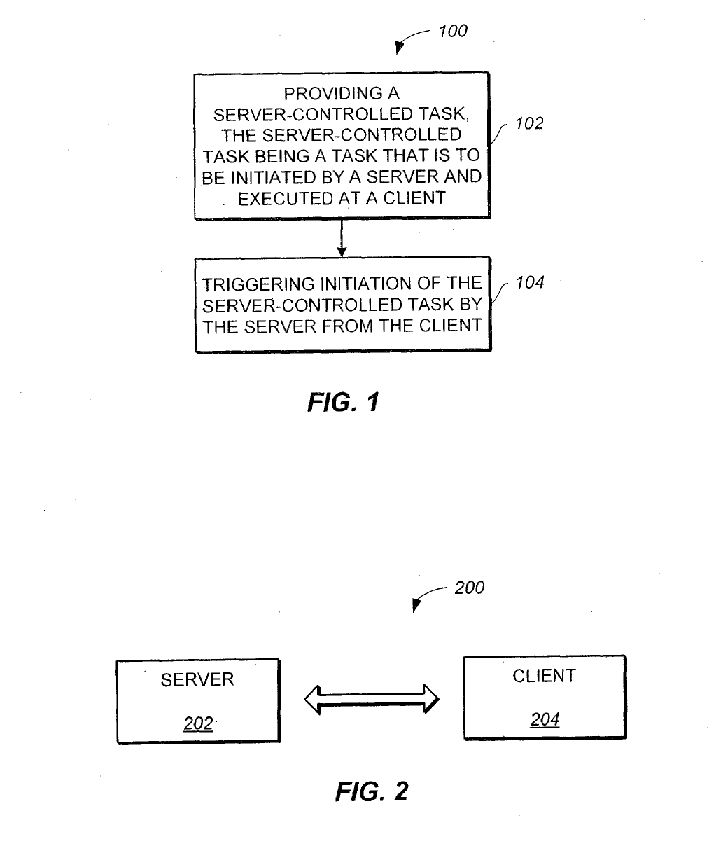

Depicted in FIG. 1 is a process 100 for initiating execution of server-controlled tasks according to an implementation of the invention. At 102, a server-controlled task is provided. The server-controlled task is a task that is to be initiated by a server and executed at a client in communication with the server. In one implementation, the server-controlled task may be, for instance, a basic scan in which the client's hardware components are inventoried. In addition, the server and the client may be in communication with one another via a network, such as a local area network (LAN), a wide area network (WAN), and the like. At 104, initiation of the server-controlled task by the server is triggered from the client.

By allowing a client to trigger initiation of a server-controlled task by a server, the client is able to force the server to cause execution of the server-controlled task at the client. In other words, client-side on-demand execution of a server-controlled task is provided. Thus, initiating execution of a server-controlled task can be accomplished remotely without having to directly interface with the server. As a result, initiating execution of server-controlled tasks by the server is more convenient, less likely to cause delays, and less prone to errors.

FIG. 2 illustrates a system 200 according to an implementation of the invention. System 200 includes a server 202 and a client 204 in communication with server 202. Client 204 is operable to trigger initiation of a server-controlled task by server 202. The server-controlled task is a task that is to be initiated by server 202 and executed at client 204, such as, a basic scan. After the server-controlled task is initiated by server 202, client 204 may have to first download a program, a file, an image, an executable, or the like, from server 202 or another server (not shown) before the server-controlled task can be executed at client 204.

In one implementation, server 202 is a PXE server and client 204 is a PXE client. PXE is a protocol that was developed to enable computers to boot from a network. PXE piggybacks upon several existing network protocols, such as DHCP (Dynamic Host Configuration Protocol), TCP/IP (Transmission Control Protocol/Internet Protocol), and TFTP (Trivial File Transfer Protocol). With PXE, a small rudimentary network stack is built during POST (Power-On Self-Test), i.e., after the computer is turned on, but before an operating system is loaded. The small rudimentary network stack that is built can be used to boot the computer.

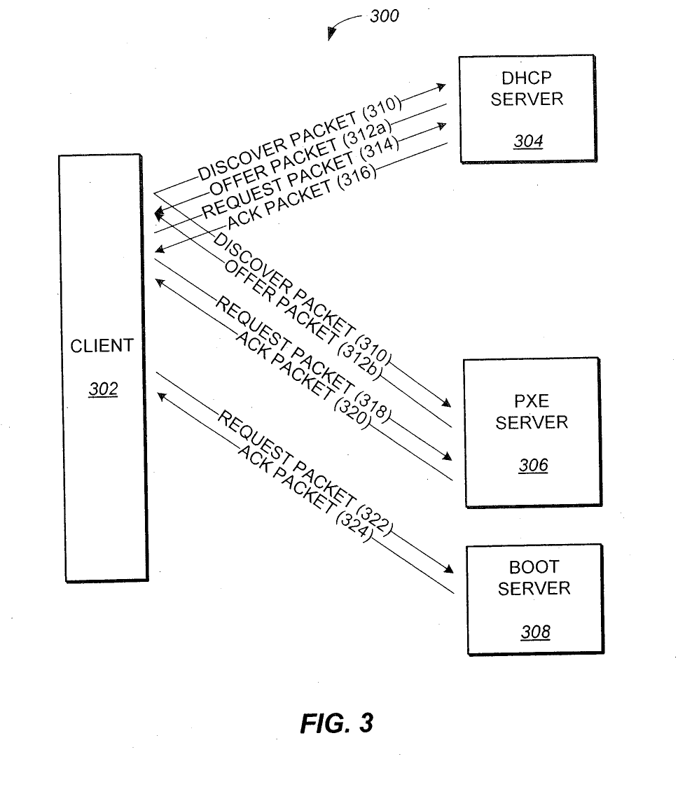

Shown in FIG. 3 is an example of a PXE session in a system 300 according to an implementation of the invention. System 300 includes a PXE client 302, a DHCP server 304, a PXE server 306 (sometimes referred to as a Proxy DHCP server), and a boot server 308. Although DHCP server 304, PXE server 306, and boot server 308 are shown as being separate from one another, two or more of servers 304-308 may combined into a single server (i.e., two or more of servers 304-308 may run on a single computer). For example, DHCP server 304 and PXE server 306 may be combined into one server or PXE server 306 and boot server 308 may be combined into one server.

The PXE session begins when client 302 broadcasts a discover packet 310 (sometimes referred to as a DHCPDISCOVER packet), which contains an extension that identifies the packet as coming from a client that implements the PXE protocol. Discover packet 310 is broadcasted because client 302 does not yet have a registered IP address. Client 302 will then receive offer packets (sometimes referred to as DHCPOFFER packets) from all DHCP and PXE servers in communication with client 302.

For purposes of simplification, only DHCP server 304 and PXE server 306 are shown in FIG. 3. As a result, FIG. 3 only shows client 302 receiving an offer packet 312a from DHCP server 304 and an offer packet 312b from PXE server 306. Offer packets 312a and 312b are also broadcasted because client 302 still does not have a registered IP address. Because client 302 does not have a registered IP address, client 302 may be identified by its GUID (Globally Unique Identifier) or UUID (Universally Unique Identifier).

Offer packet 312a from DHCP server 304 includes one or more IP addresses that are available to client 302. Offer packet 312b notifies client 302 that PXE server 306 implements the PXE protocol. Client 302 then broadcasts a request packet 314 (sometimes referred to as a DHCPREQUEST packet) requesting a specific IP address offered in packet 312a. In FIG. 3, for purposes of simplification, request packet 314 is shown as only going to DHCP server 304 even though request packet 314 is broadcasted. PXE server 306 will also receive a copy of request packet 314, but PXE server 306 will ignore the packet. Once DHCP server 304 receives request packet 314, DHCP server 304 registers the requested IP address to client 302 and sends an acknowledgement packet 316 (sometimes referred to as a DHCPACK packet) to client 302 to notify client 302 that the requested IP address has been registered to client 302.

After client 302 is notified that the requested IP address has been registered to client 302, client 302 sends a request packet 318 directly to PXE server 306 to obtain information relating to the IP address of one or more available boot servers and the name of, for instance, an executable, an image, a file, a program, or the like, to be downloaded from a boot server for execution on client 302. PXE server 306 sends the requested information to client 302 via an acknowledgement packet 320. Since only boot server 308 is shown in FIG. 3 for purposes of simplification, packet 320 will not specify more than one IP address.

Using the information received in packet 320, client 302 sends a request packet 322 to boot server 308 requesting information relating to how the executable, image, file, or program can be downloaded to client 302 for execution. Boot server 308 responds by sending an acknowledgement packet 324 with the requested information to client 302. For example, packet 324 may include the TFTP download path for the executable, image, file, or program. Client 302 then downloads (not shown) the executable, image, file, or program, and executes it (e.g., boot to the executable, image, file, or program).

Referring back to FIG. 2, when server 202 and client 204 are both PXE-enabled, triggering of the initiation of the server-controlled task by server 202 from client 204 can be implemented by defining a user option in the PXE protocol for the server-controlled task. Since the PXE protocol is based on DHCP, the PXE protocol has the same option structure as DHCP. As a result, user options can be defined for the PXE protocol just as user options can be defined for DHCP.

A keypress (e.g., pressing of a single key or a combination of keys) can be associated with the user option defined for the server-controlled task such that when the keypress is detected during POST, the user-defined option will be coded into a discover packet. Detecting of the keypress and coding of the user-defined option may be performed by a BIOS (Basic Input/Output System) of client 204.

Hence, when server 202 receives any discover packet from client 204, it can determine whether the user-defined option has been coded into the packet. If the user-defined option has been coded into the packet, then server 202 initiates execution of the server-controlled task for which the user option was defined on client 204. If no user-defined option has been coded into the packet, then server 202 proceeds normally (e.g., initiate any tasks previously scheduled for client 204 or advise client 204 to boot from a local directory if no tasks have been previously scheduled for client 204).

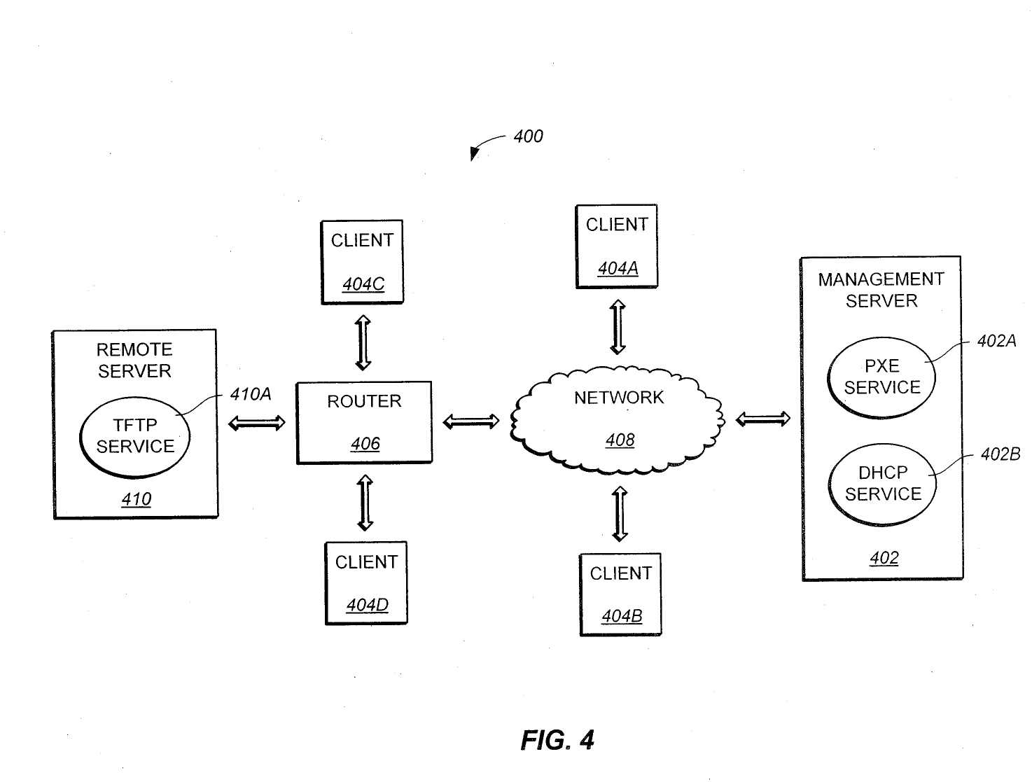

FIG. 4 depicts a system 400 according to an implementation of the invention. System 400 includes management server 402, which includes both a PXE service 402A and a DHCP service 402B. Management server 402 is in communication with clients 404A and 404B, and router 406 via a network 408. Network 408 may be, for instance, a LAN, a WAN, or something else. System 400 also includes a remote server 410, which includes a TFTP service 410A, and additional clients 404C and 404D. Remote server 410 and clients 404C and 404D communicate with management server 402 through router 406 via network 408. In one implementation, not all clients 404A-D are PXE-enabled.

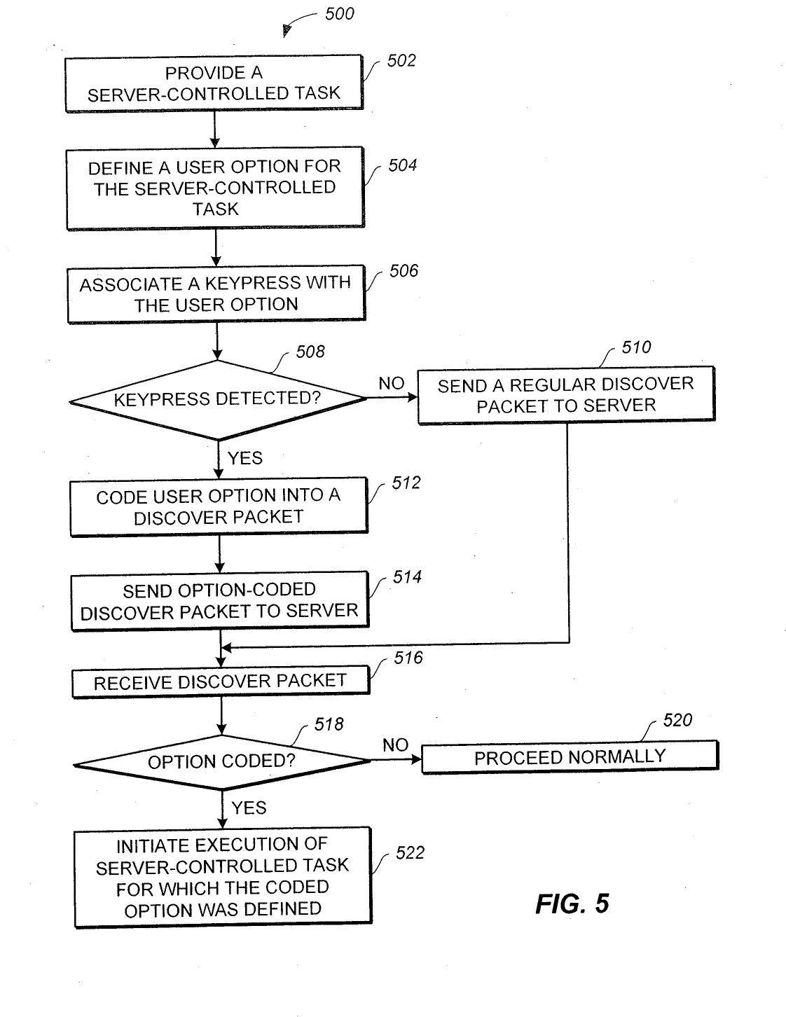

Illustrated in FIG. 5 is a process 500 for initiating execution of server-controlled tasks according to an implementation of the invention. Process 500 will be described in conjunction with FIG. 4 as process 500 can be implemented by system 400. At 502 a server-controlled task is provided. The server-controlled task is a task that is to be initiated by a server (e.g., management server 402) and executed at a client (e.g., clients 404A-D) in communication with the server.

At 504, a user option is defined for the server-controlled task. For management server 402, a PXE/DHCP user option would be defined since that is the protocol used by server 402. A keypress is associated with the user option at 506. The keypress can be a single key or a combination of keys. At 508, a determination is made at the client (e.g., clients 404A-D) as to whether the keypress has been detected. If the keypress is not detected at 508, then the client (e.g., clients 404A-D) sends a regular discover packet to the server (e.g., management server 402) at 510.

If the keypress is detected at 508, the user option is coded into a discover packet at 512. At 514, the option-coded discover packet is sent by the client (e.g., clients 404A-D) to the server (e.g., management server 402). A discover packet is received by the server (e.g., management server 402) at 516. The server (e.g., management server 402) then makes a determination at 518 as to whether the received discover packet has been coded with the user option.

The server (e.g., management server 402) proceeds normally at 520 when the received discover packet is a regular discover packet (i.e., non-option coded). On the other hand, when the discover packet received by the server (e.g., management server 402) has been coded with the user option, at 522, the server initiates execution of the server-controlled task for which the user option coded in the discover packet was defined at the client (e.g., clients 404A-D).

The server-controlled task may be provided at the server (e.g., management server 402). For example, an executable, an image, a file, or a program necessary for the client to carry out the task is stored on the server (e.g., management server 402). Alternatively, the server-controlled task may be provided at a secondary server (e.g., remote server 410).

In one implementation, the client (e.g., clients 404A-D) downloads the executable, image, file, or program from the server (e.g., management server 402) in order to execute the server-controlled task. In another implementation, the client (e.g., clients 404A-D) downloads the executable, image, file, or program from the secondary server (e.g., remote server 410). If the executable, image, file, or program requested by the client (e.g., clients 404A-D) is not available on the secondary server (e.g., remote server 410), the secondary server (e.g., remote server 410) may have to contact the server (e.g., management server 402) to obtain the executable, image, file, or program requested by the client (e.g., clients 404A-D).

The invention can take the form of an entirely hardware implementation, an entirely software implementation, or an implementation containing both hardware and software elements. In one aspect, the invention is implemented in software, which includes, but is not limited to, application software, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W).

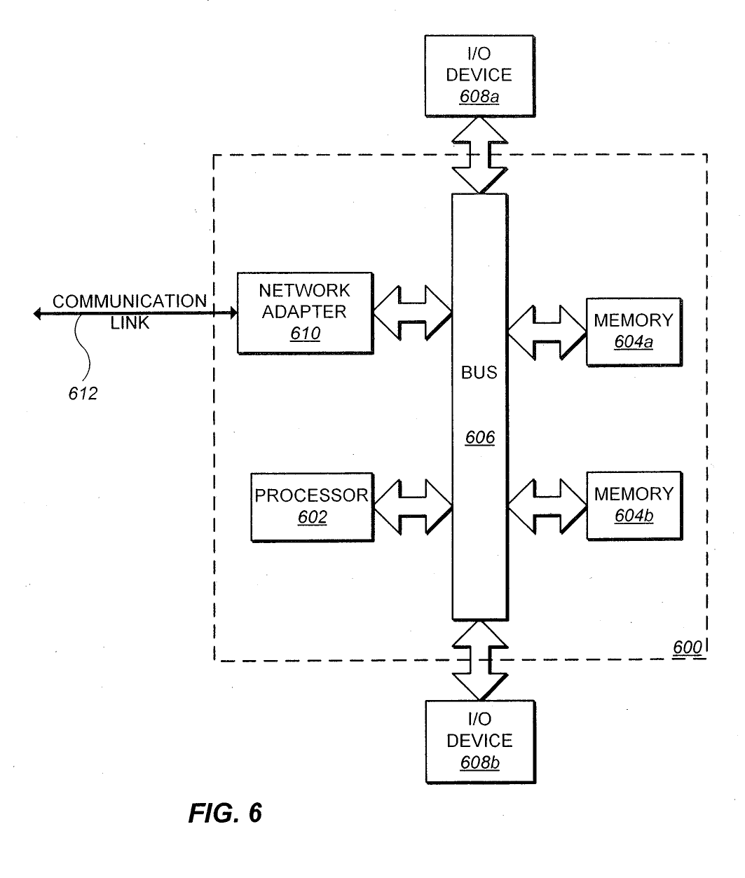

FIG. 6 shows a data processing system 600 suitable for storing and/or executing program code. Data processing system 600 includes a processor 602 coupled to memory elements 604a-b through a system bus 606. In other implementations, data processing system 600 may include more than one processor and each processor may be coupled directly or indirectly to one or more memory elements through a system bus.

Memory elements 604a-b can include local memory employed during actual execution of the program code, bulk storage, and cache memories that provide temporary storage of at least some program code in order to reduce the number of times the code must be retrieved from bulk storage during execution. As shown, input/output or I/O devices 608a-b (including, but not limited to, keyboards, displays, pointing devices, etc.) are coupled to data processing system 600. I/O devices 608a-b may be coupled to data processing system 600 directly or indirectly through intervening I/O controllers (not shown).

In the implementation, a network adapter 610 is coupled to data processing system 600 to enable data processing system 600 to become coupled to other data processing systems or remote printers or storage devices through communication link 612. Communication link 612 can be a private or public network. Modems, cable modems, and Ethernet cards are just a few of the currently available types of network adapters.

While various implementations for initiating execution of server-controlled tasks have been described, the technical scope of the present invention is not limited thereto. For example, the present invention is described in terms of particular systems having certain components and particular methods having certain steps in a certain order. One of ordinary skill in the art, however, will readily recognize that the methods described herein can, for instance, include additional steps and/or be in a different order, and that the systems described herein can, for instance, include additional or substitute components. Hence, various modifications or improvements can be added to the above implementations and those modifications or improvements fall within the technical scope of the present invention.

What is claimed is:

1. A method for initiating execution of server-controlled tasks, the method comprising:
providing a server-controlled task, the server-controlled task being a task that is to be initiated by a server and executed at a client in communication with the server; and
triggering initiation of the server-controlled task by the server from the client.

2. The method of claim 1, wherein the server is a preboot execution environment (PXE) server and the client is a PXE client.

3. The method of claim 1, wherein the server-controlled task is a basic scan that inventories hardware components of the client when executed at the client.

4. The method of claim 1, further comprising:
defining a user option for the server-controlled task; and
associating a keypress with the user option, the keypress being a single key or a combination of keys.

5. The method of claim 4, wherein triggering initiation of the server-controlled task comprises:
receiving a discover packet;
determining whether the discover packet has been coded with the user option; and
initiating execution of the server-controlled task responsive to the discover packet being coded with the user option.

6. The method of claim 4, wherein triggering initiation of the server-controlled task comprises:
detecting the keypress during POST (Power-On Self-Test);
coding the user option into a discover packet responsive to detecting the keypress during POST; and
sending the option-coded discover packet to the server.

7. The method of claim 1, wherein an executable necessary for the client to carry out the server-controlled task is stored on the server.

8. The method of claim 7, wherein triggering initiation of the server-controlled task comprises:
downloading the executable to the client for execution of the server-controlled task.

9. A system for initiating execution of server-controlled tasks, the system comprising:
a server; and
a client in communication with the server, the client being operable to trigger initiation of a server-controlled task by the server, the server-controlled task being a task that is to be initiated by the server and executed at the client.

10. The system of claim 9, wherein the server is a preboot execution environment (PXE) server and the client is a PXE client.

11. The system of claim 9, wherein the server-controlled task is a basic scan that inventories hardware components of the client when executed at the client.

12. The system of claim 9, wherein a user option has been defined for the server-controlled task and a keypress has been associated with the user option, the keypress being a single key or a combination of keys.

13. The system of claim 12, wherein the server is operable to receive a discover packet from the client,
determine whether the discover packet has been coded with the user option, and initiate execution of the server-controlled task responsive to the discover packet being coded with the user option.

14. The system of claim 12, wherein the client is further operable to
detect the keypress during POST (Power-On Self-Test),
code the user option into a discover packet responsive to detecting the keypress during POST, and
send the option-coded discover packet to the server.

15. A computer program product comprising a computer readable medium, the computer readable medium including a computer readable program for initiating execution of server-controlled tasks, wherein the computer readable program when executed on a computer causes the computer to:
provide a server-controlled task, the server-controlled task being a task that is to be initiated by a server and executed at a client in communication with the server; and
trigger initiation of the server-controlled task by the server from the client.

16. The computer program product of claim 15, wherein the server is a preboot execution environment (PXE) server and the client is a PXE client.

17. The computer program product of claim 15, wherein the server-controlled task is a basic scan that inventories hardware components of the client when executed at the client.

18. The computer program product of claim 15, wherein the computer readable program further causes the computer to:
define a user option for the server-controlled task; and
associate a keypress with the user option, the keypress being a single key or a combination of keys.

19. The computer program product of claim 15, wherein trigger initiation of the server-controlled task comprises:
receive a discover packet;
determine whether the discover packet has been coded with the user option; and
initiate execution of the server-controlled task responsive to the discover packet being coded with the user option.

20. The computer program product of claim 15, wherein trigger initiation of the server-controlled task comprises:
detect the keypress during POST (Power-On Self-Test);
code the user option into a discover packet responsive to detecting the keypress during POST; and
send the option-coded discover packet to the server.
